(19) United States
(12) Patent Application Publication
(10) Pub. No.: US 2011/0111947 A1
(43) Pub. Date: May 12, 2011

(54) DIELECTRIC CERAMIC COMPOSITION AND ELECTRONIC COMPONENT

(75) Inventors: Hidesada NATSUI, Tokyo (JP); Tatsuya ISHII, Tokyo (JP); Takeo TSUKADA, Tokyo (JP); Shinichi YODA, Sagamihara-shi (JP); Kentei YONO, Sagamihara-shi (JP)

(73) Assignees: TDK CORPORATION, TOKYO (JP); JAPAN AEROSPACE EXPLORATION AGENCY, Chofu-shi (JP)

(21) Appl. No.: 12/941,422

(22) Filed: Nov. 8, 2010

(30) Foreign Application Priority Data
Nov. 6, 2009 (JP) 2009-255512
Sep. 30, 2010 (JP) 2010-222704

(51) Int. Cl. C04B 35/468; C01F 11/02

(52) U.S. Cl. 501/137; 423/598

(57) ABSTRACT

The disclosed is a dielectric ceramic composition in which dielectric particles 2a are formed. The dielectric particle 2a has a core 22a comprised of hexagonal barium titanate, and a shell 24a formed on an outer circumference of the core 22a and comprised of cubical or tetragonal barium titanate. The purpose of the present invention is to provide a new dielectric ceramic composition, in which permittivity is hardly lowered due to size effect, a good balance between high insulation resistance and permittivity can easily be achieved, and changes in insulation resistance and specific permittivity due to temperature are small; and an electronic component such as a multilayer ceramic capacitor using the dielectric ceramic composition as its dielectric layer.

### BACKGROUND OF THE INVENTION

1. Field of the Invention

The present invention relates to a new dielectric ceramic composition and an electronic component such as a multilayer ceramic capacitor in which the dielectric ceramic composition is used as its dielectric layer.

2. Description of the Related Art

Barium titanate is one of dielectric materials used in an electronic component such as a capacitor. The barium titanate generally has a tetragonal or cubical structure. Conventionally, it has been possible to make layers thinner and to stack more layers by pulverization of barium titanate, resulting in capacity expansion of the capacitor and the like.

However, with pulverization of barium titanate, a phenomenon called a size effect, in which permittivity of raw material itself is reduced, has become more prominent, and become a major problem for future development in electronic components.

Namely, in a tetragonal barium titanate, capacity expansion may not be achievable by making layers thinner and stacking more layers as before because permittivity can be lowered due to the size effect, and it is therefore required to develop dielectric materials showing no size effect or having small impact thereof.

As the dielectric material, a hexagonal barium titanate has attracted attention, for instance. However, in the crystal structure of barium titanate, the hexagonal structure is a metastable phase, and can only exist normally at 1460° C. or more. Therefore, for obtaining the hexagonal barium titanate at room temperature, it is necessary to rapidly cool down from high temperature of 1460° C. or more.

Consequently, Nonpatent Literature 1, for example, discloses the use of BaCO₃, TiO₂ and Mn₃O₄ as starting materials and heat treatment thereof. This may allow lowering transformation temperature to the hexagonal structure, so that it is possible to rapidly cool down from a temperature of 1460° C. or less to obtain a hexagonal barium titanate in which Mn is in solid solution state.

However, when actually using the hexagonal barium titanate obtained by the method disclosed in the Nonpatent Literature 1 as a dielectric layer of a capacitor, particle size constituting the dielectric layer may be increased, so that it is difficult to use this for a multilayer capacitor.

Note that the present inventors have proposed that permittivity can be improved by adding La and the like to a hexagonal barium titanate. However, the hexagonal barium titanate to which La and the like is added shows reduction in insulation resistance and large change in specific permittivity due to atmospheric temperature, and therefore, it is unsuitable to use this without modification for an electronic component such as a capacitor.

[Nonpatent Literature 1] Wang Sea-Fue and four others, “Properties of Hexagonal Ba(Ti₁₋ₓMnₓ)O₃ Ceramics: Effects of Sintering Temperature and Mn Content”, Japanese Journal of Applied Physics, 2007, Vol. 46, No. 5A, 2978-2983

### BRIEF SUMMARY OF THE INVENTION

The present invention has been achieved in view of this situation, and has purposes to provide a new dielectric ceramic composition, in which permittivity is hardly lowered due to size effect, a good balance between high insulation resistance and permittivity can easily be achieved, and changes in insulation resistance and specific permittivity due to temperature are small; and an electronic component such as a multilayer ceramic capacitor in which the dielectric ceramic composition is used as a dielectric layer.

To achieve the above purposes, in a dielectric ceramic composition according to the present invention in which dielectric particles are formed,

said dielectric particles comprise
a core comprised of hexagonal barium titanate, and
a shell, formed on an outer circumference of said core and comprised of cubical or tetragonal barium titanate.

The dielectric ceramic composition according to the present invention comprises, instead of dielectric particles consisting only of hexagonal barium titanate, dielectric particles including the core comprised of hexagonal barium titanate and the shell comprised of cubical or tetragonal barium titanate. The dielectric particles can be expected to hardly lower permittivity even due to size effect because the core is comprised of hexagonal barium titanate.

Also, the present inventors have confirmed that it is possible to achieve a good balance between high insulation resistance and permittivity by adopting a core shell structure such that the core comprised of hexagonal barium titanate is coated with the shell comprised of cubical or tetragonal barium titanate. In addition, it has been confirmed that change in insulation resistance and specific permittivity due to temperature can be reduced by adopting such a core shell structure.

Preferably,

said hexagonal barium titanate is expressed by a general formula, (Ba_{1-α}M1_{α})_{A} (Ti_{1-β}M2_{β})_{B}O₃;

an effective ionic radius of said M1 is −20% or more to +20% or less (within ±20%) with respect to an effective ionic radius of 12-coordinated Ba²⁺;

an effective ionic radius of said M2 is −20% or more to +20% or less (within ±20%) with respect to an effective ionic radius of 6-coordinated Ti⁴⁺; and

said A, B, α and β satisfy the following relations: 0.900≦(A/B)≦1.040, 0≦α≦0.1 and 0≦β≦0.2.

Preferably, said cubical or tetragonal barium titanate is different in crystal structure from said hexagonal barium titanate but is expressed by said general formula, (Ba_{1-α}M1_{α})_{A} (Ti_{1-β}M2_{β})_{B}O₃.

A grain boundary may be formed between said dielectric particles, and additive elements may be dispersed in said grain boundary and/or said shell.

The electronic component according to the present invention has a dielectric layer comprised of any one of the above-described dielectric ceramic compositions.

### BRIEF DESCRIPTION OF THE DRAWINGS

FIG. 1 is a schematic sectional view of a multilayer ceramic capacitor according to one embodiment of the present invention.

FIG. 2 is a sectional view of an enlarged key part of the dielectric layer shown in FIG. 1.

FIG. 3 is a pattern of electron analysis of the core and the shell in the core shell structure of the dielectric particle shown in FIG. 2, measured by a transmission electron microscope.

FIG. 4 is a result of XRD measurement of the dielectric particle shown in FIG. 2, a graph in which oxygen partial pressure at firing is changed.

FIG. 5 is a conceptual diagram of the dielectric particle shown in FIG. 2.

FIG. 6 is a graph showing a change in insulation resistance with temperature of a dielectric ceramic composition according to Example 1 of the present invention.

FIG. 7 is a graph showing a change in specific permittivity with temperature of the dielectric ceramic composition according to Example 1 of the present invention.

FIG. 8 is a graph showing a change in insulation resistance with temperature of a dielectric ceramic composition according to Example 3 of the present invention.

FIG. 9 is a graph showing a change in specific permittivity with temperature of the dielectric ceramic composition according to Example 3 of the present invention.

### DETAILED DESCRIPTION OF THE INVENTION

Hereinafter, the present invention will be explained based on embodiments shown in the drawings.

### First Embodiment

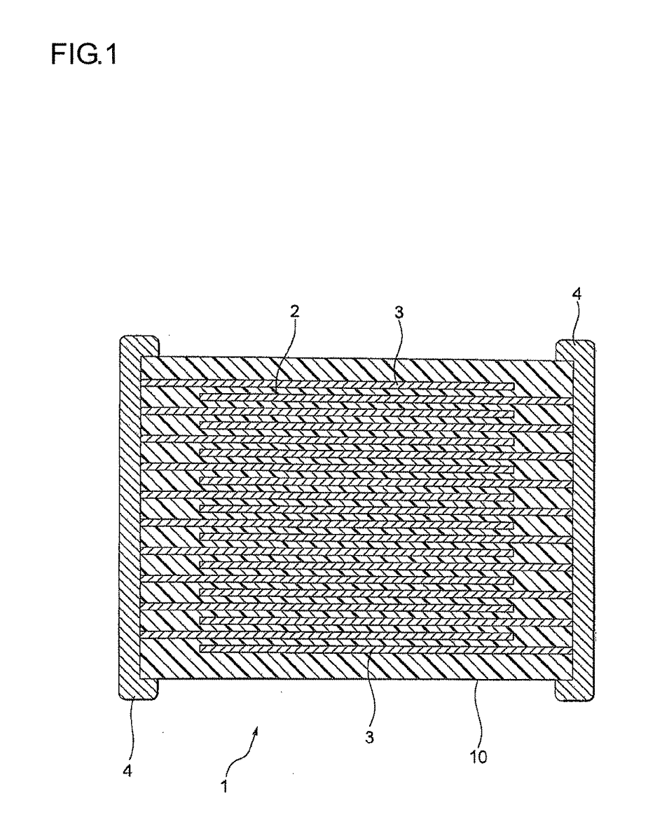

The present embodiment will be explained by exemplifying a multilayer ceramic capacitor 1 shown in FIG. 1 as an electronic component, but the present invention is not necessarily limited to a capacitor with stacking dielectric layers. Also, the present invention can be applied to any other electronic components having a dielectric layer as well as capacitors.

Multilayer Ceramic Capacitor

As shown in FIG. 1, the multilayer ceramic capacitor 1 as an electronic component according to one embodiment of the present invention has a capacitor element body 10 in which dielectric layers 2 and internal electrode layers 3 are alternately stacked. At both ends of the capacitor element body 10, a pair of external electrodes 4 is formed, which are respectively conducted with internal electrode layers 3 alternately arranged inside the element body 10. The internal electrode layers 3 are stacked such that each end face is alternately exposed to surfaces of two opposed ends of the capacitor element body 10. The pair of external electrodes 4 is formed on both ends of the capacitor element body 10, and connected to the exposed end face of the alternately arranged internal electrode layers 3, constituting a capacitor circuit.

The outer shape and dimension of the capacitor element body 10 are not particularly limited, and can be properly determined depending on the intended use. Normally, the outer shape can be approximately rectangular parallelepiped shape, and the dimension can normally be about (0.4 to 5.6 mm) in length, (0.2 to 5.0 mm) in width and (0.2 to 1.9 mm) in height.

Dielectric Layer

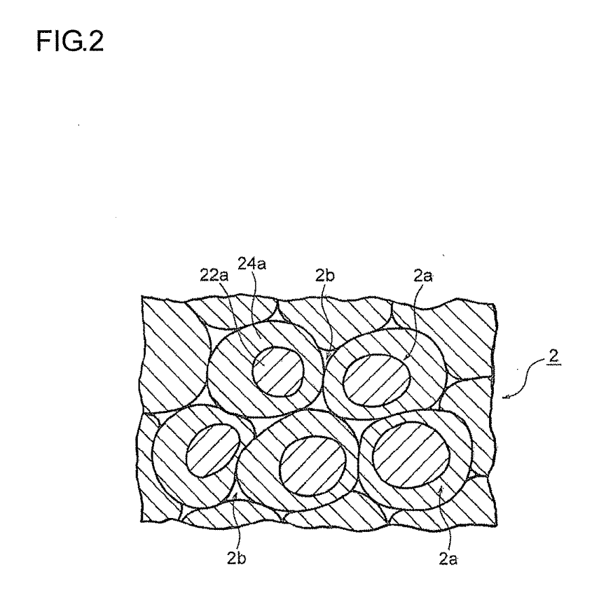

The dielectric layer 2 shown in FIG. 1 is constituted, as shown in FIG. 2, to include a plurality of dielectric particles (crystal grains) 2a and grain boundaries 2b formed between pluralities of adjacent dielectric particles 2a. The dielectric particle (crystal grain) 2a is comprised of a core 22a, comprised of hexagonal barium titanate, and a shell 24a, formed on an outer circumference of the core 22a and comprised of cubical or tetragonal barium titanate.

In the present embodiment, a core shell structure of the dielectric particle 2a means a structure in which the core 22a as a central portion of the dielectric particle and the shell 24a coating the surface of the core 22a are different in crystal structure but are integrated and have approximately same composition. Note that “approximately same composition” here means that some subcomponents may be dispersed in the shell and that the core 22a and the shell 24a are somehow different in compositions when more appropriate.

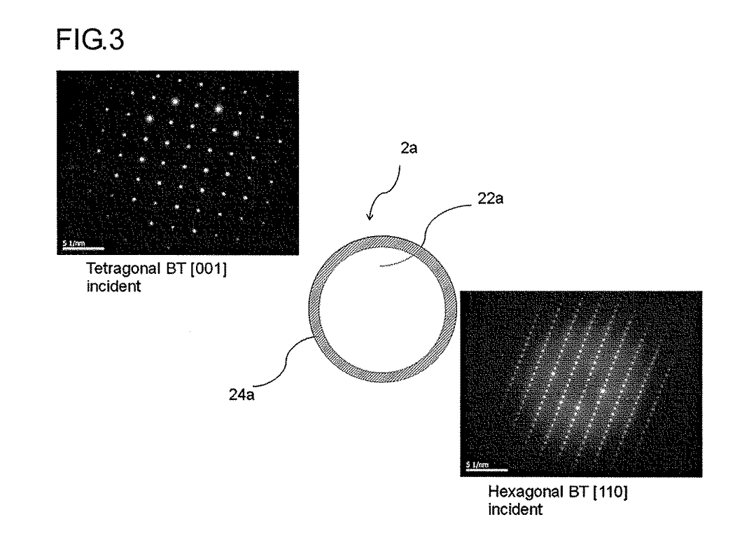

As shown in FIG. 3, as a result of electron analysis on the core 22a via measurement by a transmission electron microscope, a pattern specific to hexagonal barium titanate can be observed, and as a result of electron analysis on the shell 24a via measurement by the transmission electron microscope, a pattern specific to tetragonal or cubical barium titanate can be observed.

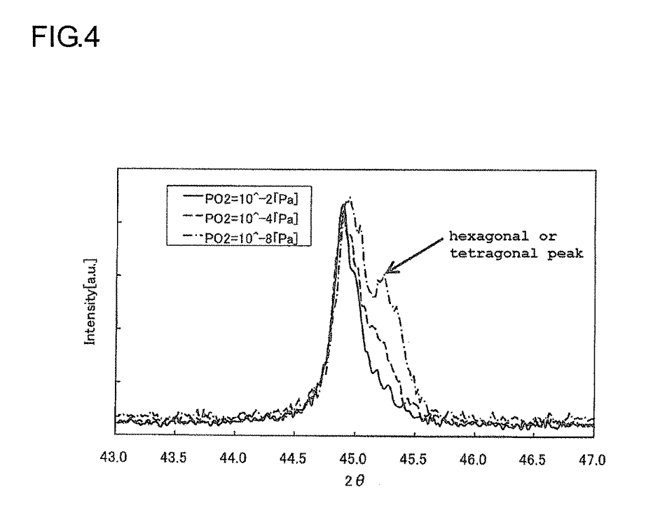

Also, when measuring an X-ray diffraction (XRD) pattern by supposedly using an X-ray diffractometer for only a portion corresponding to the core 22a of the dielectric particle 2a shown in FIG. 2, only a peak specific to hexagonal barium titanate can come out as shown in solid line in FIG. 4. It is difficult to measure only the portion corresponding to the core 22a of the dielectric particle 2a shown in FIG. 2 with an existing X-ray diffractometer while it is easy to measure an X-ray diffraction (XRD) pattern for a part of the dielectric layer 2.

In case of such a measurement in the present embodiment, a peak specific to cubical or tetragonal barium titanate can come out along with the peak specific to hexagonal barium titanate as shown in dashed-dotted line in FIG. 4. This can lead to assume that the dielectric particle constituting the dielectric layer 2 according to the present embodiment has the above-mentioned core shell structure.

In the present embodiment, the dielectric layer 2 is produced by using raw powder as main component, which is comprised of hexagonal barium titanate and contains almost no raw powder for cubical or tetragonal barium titanate, adding subcomponent if required and firing, as described below. Based on this, when there appear two peaks in the measured XRD pattern as with the dashed-dotted line shown in FIG. 4, it can be assumed that the dielectric particle 2a has the above-mentioned core shell structure.

In the core shell structure of the present embodiment, it is not necessary that the shell 24a completely coats whole circumference of the core 22a, and the core 22a may partially be exposed. Based on this point of view, as shown in FIG. 5, a maximum thickness “t1” in the shell 24a of the dielectric particle 2a is more than 0 which is a thickness enough not to eliminate the core 24a of the dielectric particle 2a, and a minimum thickness “t2” may be 0.

In the core shell structure of the present embodiment, a boundary of the core 22a and shell 24a is not necessarily definite, and at least, the hexagonal barium titanate may exist close to the center of the dielectric particle 2a while the cubical or tetragonal shell 24a may exist near the surface (close to grain boundary).

Note that an average particle diameter “D50” (unit in gm) of the whole dielectric particles 2a in the dielectric layer 2 can be defined as a value obtained by cutting the capacitor element body 10 in a stacking direction of the dielectric layer 2 and internal electrode layer 3, measuring an average area of 200 or more of the dielectric particles 2a in the cross-sectional surface shown in FIG. 2, and calculating a diameter assuming that the particles are circular, followed by multiplying the diameter by 1.5. In the present embodiment, the upper limit of the average particle diameter “D50” of the whole dielectric particles 2a can be the thickness of the dielectric layer 2, and “D50” can be preferably 25% or less, more preferably 15% or less, of the thickness of the dielectric layer 2.

The grain boundary 2b is normally composed of oxides of materials constituting dielectric materials or internal electrode materials, oxides of separately added materials, and oxides of materials contaminated as impurities during the process.

In the present embodiment, the dielectric ceramic composition forming the core 22a and shell 24a are not particularly limited, and can preferably be constituted as below.

Namely, the core 22a in the dielectric layer 2 shown in FIG. 2 is expressed by the following general formula, (Ba_{1-α}M1_{α})_{A} (Ti_{1-β}M2_{β})_{B}O₃,

an effective ionic radius of the above M1 is −20% or more to +20% or less (within ±20%) with respect to an effective ionic radius of 12-coordinated Ba²⁺;

an effective ionic radius of the above M2 is −20% or more to +20% or less (within ±20%) with respect to an effective ionic radius of 6-coordinated Ti⁴⁺; and

the above A, B, α and β satisfy the following relations: 0.900≦(A/B)≦1.040, 0≦α≦0.1 and 0≦β≦0.2.

In the above general formula, α indicates a substitution ratio of the element M1 to Ba (a content of M1 in the hexagonal-based barium titanate powder). In the present embodiment, the capacitor 1 shown in FIG. 1 can be used for temperature compensation, and is required to show small changes in properties such as specific permittivity in a broad temperature range, but the specific permittivity of the dielectric layer 2 may not necessarily be so high, Based on the point of view, in the present embodiment, α satisfies preferably 0≦α<0.003, further preferably 0≦α≦0.002. A large content of M1 may result in higher transformation temperature to the hexagonal structure, so that it tends to be difficult to obtain powder having large specific surface as raw powder.

Ba occupies a position of A site as Ba²⁺ in the hexagonal structure. The element M1 is substituted for Ba to satisfy the above range, and may exist at the position of A site, and the A site may be occupied only by Ba. Namely, the element M1 may not be included in the hexagonal barium titanate.

As mentioned above, the element M1 can preferably have the effective ionic radius of −20% or more to +20% or less (within ±20%) with respect to the effective ionic radius (1.61 pm) of 12-coordinated Ba²⁺. Ba can easily be substituted with M1 because M1 has such an effective ionic radius.

Specifically, the element M1 is preferably at least one selected from Dy, Gd, Ho, Y, Er, Yb, La, Ce and Bi. The element M1 may be selected depending on the desired properties, and preferably be La.

In the above general formula, β indicates a substitution ratio of the element M2 to Ti (a content of M2 in the hexagonal-based barium titanate powder), and β is preferably satisfies 0.03≦β≦0.20, further preferably 0.05≦β≦0.15 in the present embodiment. When the content of the element M2 is either too low or too high, transformation temperature to the hexagonal structure may be increased, so that it tends not to obtain powder having large specific surface as raw powder.

Ti occupies a position of B site as Ti⁴⁺ in the hexagonal structure. In the present embodiment, the element M2 is substituted for Ti to satisfy the above range, and exists at the position of B site. Namely, the element M2 is solid soluble in barium titanate. By the existence of the element M2 at the position of B site, transformation temperature from the tetragonal/cubical structure to the hexagonal structure can be lowered in the barium titanate.

As mentioned above, the element M2 can preferably have the effective ionic radius of −20% or more to +20% or less (within ±20%) with respect to the effective ionic radius of 6-coordinated Ti⁴⁺. Ti can easily be substituted with M1 because the element M2 has such an effective ionic radius. As the element M2, Mn, Ga, Cr, Co, Fe, Ir and Ag may be specifically exemplified, and preferably Mn.

The A and B in the above formula indicate a ratio of the elements (Ba and M1) occupying A site and a ratio of the elements (Ti and M2) occupying B site, respectively. In the present embodiment, A and B preferably satisfy 1.000<A/B≦1.040, further preferably 1.006≦A/B≦1.036.

When A/B is too small, reactivity may be high at preparation of barium titanate during the production of the raw powder, and grain growth may easily occur with respect to temperature. Therefore, it may be difficult to obtain fine powder, and the desired specific surface may hardly be obtained. On the other hand, when A/B is too large, Ba-rich orthobarium titanate (Ba₂TiO₄) may be generated as a hetero-phase because the ratio of Ba is increased during the production of the raw powder, which is not preferable.

The core 22a and shell 24a shown in FIG. 2 are different in crystal structure, but the dielectric ceramic compositions thereof are approximately same. Note that subcomponents included in the raw powder of the dielectric ceramic composition may be dispersed in the shell 24a and grain boundary 2b. As the subcomponents, for example, the following compounds may be used. Note that the amount of oxygen (O) may be slightly deviated from the stoichiometric composition in a variety of compositional formulae of oxides shown below.

Namely, the subcomponents include:

at least one alkaline-earth oxide selected from a group consisting of MgO, CaO and BaO,

at least one metal oxide selected from a group consisting of Mn₃O₄ CuO, Cr₂O₃ and Al₂O₃,

at least one oxide of rare-earth selected from a group consisting of Y, La, Ce, Pr, Nd, Sm, Gd, Tb, Dy, Ho and Yb, and

glass component including SiO₂.

The glass component including SiO₂ is used as a sintering auxiliary agent, and ZnO—B₂O₃—SiO₂ glass, B₂O₃—SiO₂ glass, BaO—CaO—SiO₂, SiO₂ and the like can preferably be used. The amount of the glass component is, in terms of SiO₂, preferably 0 to 5 parts by mole, further preferably 0.5 to 2 parts by mole, with respect to 100 parts by mole of the main component including barium titanate expressed by the above-mentioned general formula.

Amounts of other subcomponents except for the glass component are, in terms of metal element, preferably 0 to 5 parts by mole, further preferably 0.1 to 3 parts by mole, with respect to 100 parts by mole of the main component including barium titanate expressed by the above-mentioned general formula.

Note that the effective ionic radii in the present description are based on the following literature: “R. D. Shannon, Acta Crystallogr., A 32,751(1976)”.

Internal Electrode Layer

The internal electrode layer 3 shown in FIG. I can be constituted by base-metal conducting material substantially working as an electrode. For the base metal used as the conducting material, Ni or Ni alloy is preferable. As the Ni alloy, an alloy of Ni with one or more elements selected from Mn, Cr, Co, Al, Ru, Rh, Ta, Re, Os, Ir, Pt and W is preferable, and Ni content in the alloy is preferably 95 wt % or more. Note that a variety of minor components such as P, C, Nb, Fe, Cl, B, Li, Na, K, F and S may be included at about 0.1 wt % or less in the Ni or Ni alloy. In the present embodiment, the thickness of the internal electrode layer 3 can be preferably less than 2 μm, more preferably 1.5 μm or less, and thus, the internal electrode layer 3 is made thinner.

External Electrode

For the external electrode 4 shown in FIG. 1, normally, at least one of Ni, Pd, Ag, Au, Cu, Pt, Rh, Ru and Ir or alloys thereof can be used. Normally, Cu, Cu alloy, Ni or Ni alloy, Ag, Ag—Pd alloy, In—Ga alloy and the like can be used. The thickness of the external electrode 4 may properly determined depending on the intended use, and normally preferably 10 to 200 μm or so.

Production Method of Multilayer Ceramic Capacitor

First, a method for producing hexagonal-based barium titanate powder will be explained, which is raw powder of the main component for forming the dielectric layer 2 shown in FIG. 1. Initially, raw material for barium titanate, and raw material for Mn as the element M2 are prepared. Raw material for the element M1 may be prepared if required.

As the raw material for the barium titanate, barium titanate (BaTiO₃), oxides constituting barium titanate (BaO, TiO₂) and mixture thereof can be used. In addition, raw materials can be properly selected from a variety of compounds to become the above-mentioned oxides and composite oxide by firing, such as carbonate, oxalate, nitrate, hydroxide and organic metal compound, and mixed together to use. Specifically, as the raw material for the barium titanate, BaTiO₃ may be used, and BaCO₃ and TiO₂ may be used. In the present embodiment, it is preferable to use BaCO₃ and TiO₂.

Note that BaTiO₃ used as the raw material for the barium titanate may be barium titanate having a tetragonal structure, barium titanate having a cubical structure, or barium titanate having a hexagonal structure. Alternatively, mixture thereof may be used as well.

Also, as the raw material for M2, M2 compounds, such as oxide, carbonate, oxalate, nitrate, hydroxide and organic metal compound, may be properly selected and mixed to use. The raw material for the element M1 may be selected as with the raw material for M2.

Next, the prepared raw materials are weighed to have the predetermined composition ratio, mixed and if required pulverized, so that raw material mixture can be obtained. As a method for mixing and pulverizing, for example, there may be mentioned a wet method in which raw materials are thrown in a publicly-known pulverizer such as ball mill along with a solvent such as water, and then mixed/pulverized. Also, by using a dry method performed with a dry mixer and the like, the raw materials may be mixed/pulverized. To improve the dispersibility of the raw materials, it is preferable to add a dispersant. Publicly-known dispersants may be used.

Then, the obtained raw material mixture is dried if required, followed by heat treatment. Also, holding temperature in the heat treatment may be set higher than transformation temperature to hexagonal structure. In the present embodiment, the transformation temperature to hexagonal structure is lower than 1460° C., and varies depending on A/B, an amount of substitution at A site (α) and an amount of substitution at B site (β) and the like, so that the holding temperature may be changed depending on the change in transformation temperature. To increase specific surface of powder, for example, it is preferable to set at 1050 to 1250° C. The heat treatment may be done under reduced pressure.

Such a heat treatment may allow obtaining solid solution of M2 in BaTiO₃ and substituting Ti at B site with M2. As a result, the transformation temperature to hexagonal structure can be set lower than the holding temperature at the heat treatment, so that hexagonal-based barium titanate can easily be generated. Also, when the element M1 is included, the element M1 can be included in BaTiO₃ as a solid solution and substituted for Ba at A site.

Then, after the elapse of holding time in the heat treatment, the temperature can be lowered from the holding temperature in the heat treatment to room temperature to maintain the hexagonal structure. Specifically, the cooling rate is preferably set at 200° C./hour or more.

This may allow obtaining hexagonal-based barium titanate powder containing hexagonal barium titanate, in which the hexagonal structure is maintained at room temperature, as a main component. A method for evaluating whether the obtained powder is hexagonal-based barium titanate powder or not is not particularly limited, and it is evaluated by X-ray diffraction measurement in the present embodiment.

By using thus-obtained hexagonal-based barium titanate powder, an electronic component having dielectric layers and electrode layers can be produced. Specifically, the multilayer ceramic capacitor 1 shown in FIG. 1 can be produced as follows, for example. First, a dielectric paste containing the hexagonal-based barium titanate powder according to the present embodiment and an internal electrode layer paste are prepared, and these are used to form a dielectric layer before firing and an internal electrode layer before firing by doctor blade method and/or printing method. An added amount of each raw material may be determined so that the dielectric ceramic composition after firing has the above-described constitution.

Next, a green chip is produced in which the dielectric layer before firing and the internal electrode layer before firing are stacked, followed by binder removal step, firing step, and if required, annealing step, to form a sintered body. A capacitor element body 10 comprised of the sintered body is then formed with an external electrode 4, so that the multilayer ceramic capacitor 1 can be produced.

In the present embodiment, the atmosphere at firing is preferably reduction atmosphere. For atmosphere gas in the reduction atmosphere, for example, it is preferable to use humidified mixed gas of N₂ and H₂. Oxygen partial pressure in the firing atmosphere is preferably 10⁻³ to 10⁻⁶ Pa. The reduction firing at the oxygen partial pressure lower than the predetermined value may result in grain growth of hexagonal barium titanate particle, included in the dielectric layer before firing as the main component, by changing its surface to cubical or tetragonal crystal, so that it is possible that the particle has the above-mentioned core shell structure. Also, in the grain boundary and shell after firing, subcomponents included in the dielectric layer before firing are dispersed.

By controlling the oxygen partial pressure or firing temperature in the firing atmosphere, it is possible to control average particle diameter of the dielectric particle 2a constituting the dielectric layer 2 after firing, thickness of the shell 24a and the like. As shown in FIG. 4, by changing the oxygen partial pressure (PO2) from 10⁻² to 10⁻⁸ which is strongly reduced atmosphere, a peak of cubical or tetragonal crystal can be observed as well as a peak only of hexagonal crystal in the X-ray diffraction (XRD) pattern. This may allow confirming that it is possible to control cubical or tetragonal shell to be thick by changing to strongly reduced atmosphere.

In the present embodiment, it is possible to combine insulation resistance with high permittivity by adopting the core shell structure in which the core 22a comprised of hexagonal barium titanate is covered with the shell 24a comprised of cubical or tetragonal barium titanate. In addition, by adopting the core shell structure, the change in specific permittivity with temperature can be lowered.

Also, the core 22a in the dielectric ceramic composition constituting the dielectric layer 2 of the multilayer ceramic capacitor according to the present embodiment has a constitution where the amount of substitution with the element M1 is 0 or small while the amount of substitution with the element M2 is relatively large in the hexagonal barium titanate expressed by (Ba_{1-α}M1_{α})_{A} (Ti_{1-β}M2_{β})_{B}O₃. Therefore, compared to the constitution where the amount of substitution with the element M2 is 0 or small while the amount of substitution with the element M1 is large, permittivity is inferior but change rate in permittivity with temperature is small, and change rate in insulation resistance with temperature is also small. Consequently, the multilayer ceramic capacitor 1 of the present embodiment can preferably be used as a temperature compensation capacitor.

### Second Embodiment

In the second embodiment, except for changing the constitutions of the core 22a and shell 24a in the dielectric particle 2a shown in FIG. 2 from those in the first embodiment, a sample can be prepared as in the first embodiment, and its specific permittivity of the dielectric layer 2 is remarkably improved.

Namely, in the present embodiment, the core 22a in the dielectric layer 2 shown in FIG. 2 is, as in the first embodiment, hexagonal barium titanate expressed by the general formula, (Ba_{1-α}M1_{α})_{A} (T_{1-β}M2_{β})_{B}O₃ but is different in its ranges of A, B, α and β from those in the first embodiment. Note that the shell 24a has approximately same constitution with the core 22a but is different in crystal structure as in the first embodiment. Also, as in the first embodiment, the shell 24a is comprised of tetragonal or cubical barium titanate and subcomponents may be dispersed in the shell 24a and grain boundary 2b.

In the above general formula, to remarkably improve specific permittivity of the dielectric ceramic composition, the ranges of A, B, α and β are set as follows in the present embodiment.

Namely, a satisfies a relation of 0<α≦0.10, preferably 0.003≦α≦0.05. When α is small, M1 content may be decreased, and it may become difficult to remarkably improve specific permittivity. In contrast, when M1 content is too large, transformation temperature to hexagonal structure at the production of raw powder may be increased, and it tends to be hard to obtain powder having large specific surface.

Also, in the present embodiment, A and B satisfy a relation of 0.900≦A/B≦1.040, preferably 0.958≦A/B≦1.036. Furthermore, β satisfies a relation of 0≦β≦0.2, preferably 0.03≦β≦0.20, further preferably 0.03≦β≦0.10. When M2 content is 0 or small, specific permittivity can remarkably be improved, but it tends to be hard to produce raw powder of the hexagonal barium titanate because transformation temperature to hexagonal structure may be increased at the production of the raw powder.

In the present embodiment, it is possible to combine insulation resistance with high permittivity by adopting the core shell structure in which the core 22a comprised of hexagonal barium titanate is coated with the shell 24a comprised of cubical or tetragonal barium titanate. In addition, by adopting the core shell structure, the change in specific permittivity with temperature can be lowered.

Also, the core 22a in the dielectric ceramic composition constituting the dielectric layer 2 of the multilayer ceramic capacitor according to the present embodiment has a constitution where the amount of substitution with the element M1 is relatively high while the amount of substitution with the element M2 is 0 or relatively low in the hexagonal barium titanate expressed by (Ba_{1-α}M1_{α})_{A} (Ti_{1-β}M2_{β})_{B}O₃. Therefore, compared to the first embodiment, permittivity may be remarkably improved, the change rate in permittivity with temperature may be small, and the change rate in insulation resistance with temperature may also be small.

Note that the present invention is not limited to the above-described embodiments, and can be variously modified within the range of the present invention.

For example, in the above embodiments, the core shell structure is achieved in the dielectric particle 2a constituting the dielectric layer 2 after firing by controlling the oxygen partial pressure and firing temperature in the firing atmosphere when firing the element body 10. However, the core shell structure may be achieved in the dielectric particle 2a constituting the dielectric layer 2 after firing by selecting conditions for calcining hexagonal barium titanate particles.

Also, in the above embodiments, the multilayer ceramic capacitor is exemplified as the electronic component according to the present invention, but the electronic component according to the present invention is not limited to the multilayer ceramic capacitor, and may be any of those having a dielectric layer comprised of a dielectric ceramic composition having a dielectric particle with the above-described core shell structure.

### EXAMPLES

Hereinafter, the present invention will be explained based on further detailed examples, but the present invention is not limited to these examples. Note that in the following examples, “specific permittivity ε” and “insulation resistance IR” were measured as below.

(Specific Permittivity ε and Insulation Resistance)

For a capacitor sample, capacitance C was measured at reference temperature 20° C. under conditions with frequency of 1 kHz and level of input signal (measured voltage) of 0.5 Vrms/pm by using a digital LCR meter (YHP4274A by Yokogawa Electric Corporation). From thus-obtained capacitance, a thickness of a dielectric body of a multilayer ceramic capacitor and an overlapped area of internal electrodes, specific permittivity (no unit) was calculated.

Then, after DC50V was applied to the capacitor sample by using an insulation resistance tester (R8340A by Advantest Corporation) at 25° C. for 60 seconds, insulation resistance IR was measured.

### Example 1

First, raw powder of main component and raw powder of subcomponent were prepared. For the raw powder of main component, hexagonal barium titanate powder expressed by the general formula, (Ba_{1-α}M1_{α})_{A} (Ti_{1-β}M2_{β})_{B}O₃ where α=0, β=0.15, M2=Mn and A/B=1, was used. The hexagonal barium titanate powder was produced through solid-phase synthesis by using BaCO₃ (specific surface: 25 m²/g), TiO₂ (specific surface: 50 m²/g) and Mn₃O₄ (specific surface: 20 m²/g).

As a result of X-ray diffraction of the obtained hexagonal-based barium titanate powder, it was possible to confirm the obtained powder was hexagonal-based barium titanate powder. Also, as a result of measuring specific surface by BET method, a specific surface by BET method of the obtained hexagonal-based barium titanate powder was 5 m²/g.

With respect to 100 parts by mole of the hexagonal barium titanate powder, 1 part by mole of ZnO—B₂O₃—SiO₂ glass in terms of SiO₂ and 1 part by mole of an oxide of at least one rare-earth element selected from a group consisting of Y, Gd and Dy in terms of metal element were prepared. These were added with polyvinyl butyral resin and ethanol-based organic solvent, and mixed with a ball mill to form a paste, so that a dielectric layer paste was obtained.

Next, 100 parts by weight of Ni particle, 40 parts by weight of organic vehicle (in which 8 parts by weight of ethylcellulose was dissolved in 92 parts by weight of butyl carbitol) and 10 parts by weight of butyl carbitol were kneaded by triple-roll to form a paste, so that an internal electrode layer paste was obtained.

Also separately, 100 parts by weight of Cu particle, 35 parts by weight of organic vehicle (in which 8 parts by weight of ethylcellulose resin was dissolved in 92 parts by weight of butyl carbitol) and 7 parts by weight of butyl carbitol were kneaded to form a paste, so that an external electrode paste was obtained.

Then, a green sheet with a thickness of 2.5 μm was formed on PET film by using the above dielectric layer paste and the internal electrode layer paste was printed on the green sheet, followed by removal of the green sheet from the PET film. Next, the green sheet and protective green sheet (on which no internal electrode layer paste was printed) were stacked and thermocompressively bonded to obtain a green laminate. The number of layers of the sheets having internal electrodes was 100.

The green chip was then cut in a predetermined size, followed by binder removal treatment, firing and annealing in the following conditions, so that a sintered chip was obtained. The conditions for the binder removal treatment included holding temperature of 260° C. and atmosphere of in air. The firing condition included holding temperature of 1000° C. The atmosphere gas was humidified mixed gas of N₂+H₂, and was reducing gas in which oxygen partial pressure of the atmosphere gas was 1×10⁻⁸ Pa. For the anneal conditions, normal conditions were employed,

Then, end faces of the fired multilayer ceramic body were polished by sandblast, followed by transferring the external electrode paste onto the end faces and firing in humidified N₂+H₂ atmosphere at 900° C. to form external electrodes, so that a multilayer ceramic capacitor sample having a structure shown in FIG. 1 was obtained. Next, Sn plated layer and Ni plated layer were formed on the external electrode surface to obtain a sample for measurements.

The size of each of thus-obtained samples was 3.2 mm×1.6 mm×1.6 mm, the number of the dielectric layers sandwiched between the internal electrode layers was 100, and the thickness of the internal electrode layer was 2 μm. As a result of measuring X-ray diffraction (XRD) pattern for the dielectric layer by using X-ray diffractometer, the peak specific to cubical or tetragonal barium titanate was observed as well as the peak specific to hexagonal barium titanate, as shown by the dashed-dotted line shown in FIG. 4.

Also, as shown in FIG. 3, when the core 22a was measured by a transmission electron microscope for electron analysis, the pattern specific to hexagonal barium titanate was observed while the pattern specific to tetragonal or cubical barium titanate was observed when the shell 24a was measured by the transmission electron microscope for electron analysis. Namely, it was confirmed that the particles had the core shell structure.

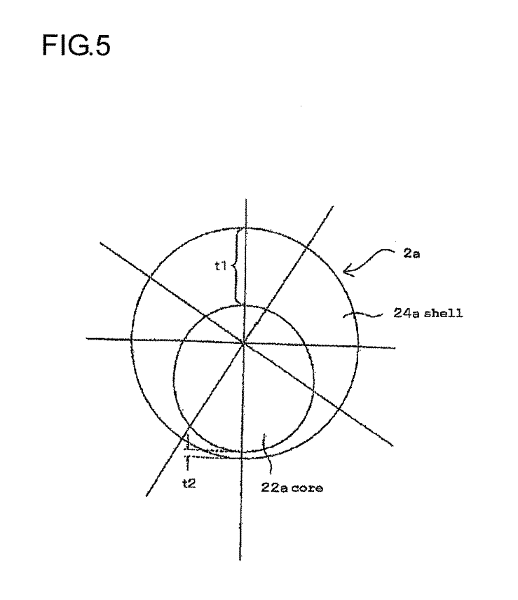

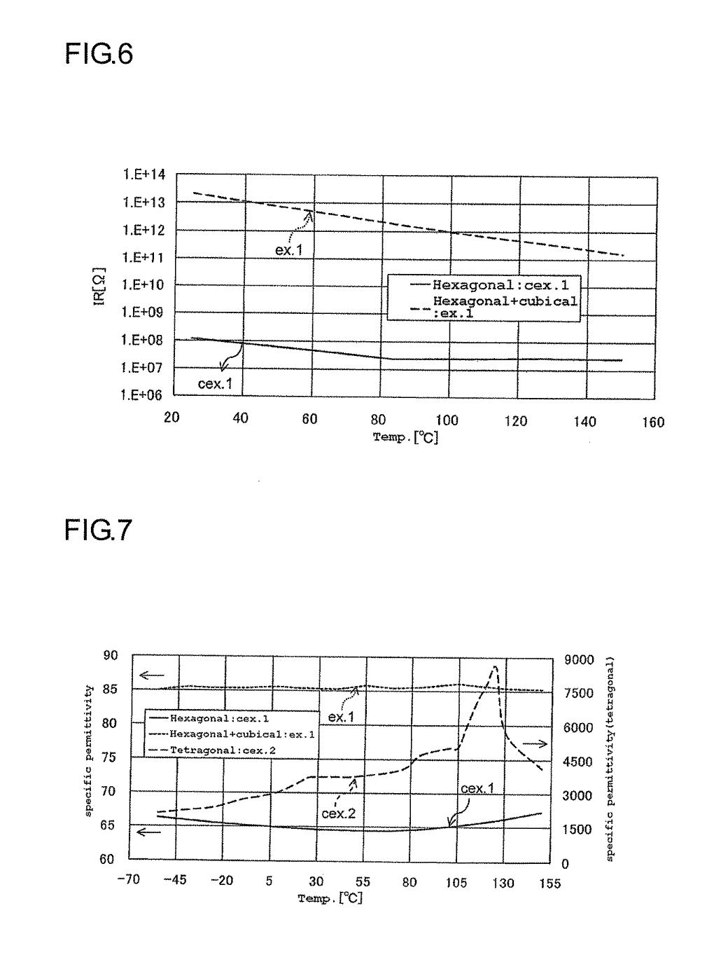

Furthermore, for the obtained capacitor sample for the present example, insulation resistance and specific permittivity were evaluated. The results are shown by the dotted line “ex. 1” in FIG. 6 and FIG. 7.

### Example 2

Except for changing the oxygen partial pressure at firing to 10⁻⁴ Pa, a capacitor sample was produced as with Example 1, and the measurements were done in the same procedures. When measuring X-ray diffraction (XRD) pattern for the dielectric layer by using X-ray diffractometer, the peak specific to cubical or tetragonal barium titanate was observed as well as the peak specific to hexagonal barium titanate, as shown by the dashed line shown in FIG. 4. Note that the peak specific to cubical or tetragonal barium titanate was low compared to Example 1. From this result, it was confirmed that the thickness of the shell 24a comprised of cubical or tetragonal barium titanate as shown in FIG. 2 was controllable.

### Comparative Example 1

Except for changing the oxygen partial pressure at firing to 10⁻¹ Pa, a capacitor sample was produced as with Example 1, and the measurements were done in the same procedures. As a result of measurements of X-ray diffraction (XRD) pattern for the dielectric layer by using X-ray diffractometer, only the peak specific to hexagonal barium titanate was observed. From this result, it was confirmed that the dielectric layer was formed by hexagonal barium titanate particle, in which the shell as shown in FIG. 2 was not formed, and grain boundary. For the obtained capacitor sample for the comparative example, insulation resistance and specific permittivity were evaluated. The results are shown by the solid line “cex. 1” in FIG. 6 and FIG. 7.

### Comparative Example 2

Except for using tetragonal barium titanate powder as raw powder of the main component, a capacitor sample was produced and specific permittivity was measured, as with Example 1. The results are shown by the dashed line “cex. 2” in FIG. 7.

### Evaluation 1

As shown in FIG. 6 and FIG. 7, it was confirmed in Example 1 (ex. 1) that insulation resistance was improved as well as specific permittivity while changes in properties with temperature were small, compared to Comparative Example 1 (cex. 1). It was also confirmed in Example (ex. 1) that changes in properties with temperature were considerably small, while permittivity was lowered in whole, compared to Comparative Example 2 (cex. 2).

### Example 3

For the raw powder of the main component, hexagonal barium titanate powder expressed by the general formula, (Ba_{1-α}M1_{α})_{A} (Ti_{1-β}M2_{β})_{B}O₃ where α=0.003, β=0, M1=La and A/B=1.04, was used. Except for producing the hexagonal barium titanate powder by using BaCO₃ (specific surface: 25 m²/g), TiO₂ (specific surface: 50 m²/g) and La(OH)₃ (specific surface: 20 m²/g) under reduced pressure via solid-phase synthesis, a capacitor sample was produced as with Example 1, and the measurements were done in the same procedures as with Example 1.

Namely, as a result of measurement of X-ray diffraction (XRD) pattern for the dielectric layer by using X-ray diffractometer, the peak specific to cubical or tetragonal barium titanate was observed as well as the peak specific to hexagonal barium titanate, as shown by the dashed-dotted line shown in FIG. 4.

Also, as shown in FIG. 3, when the core 22a was measured by the transmission electron microscope for electron analysis, the pattern specific to hexagonal barium titanate was observed while the pattern specific to tetragonal or cubical barium titanate was observed when the shell 24a was measured by the transmission electron microscope for electron analysis. Namely, it was confirmed that the particles had the core shell structure.

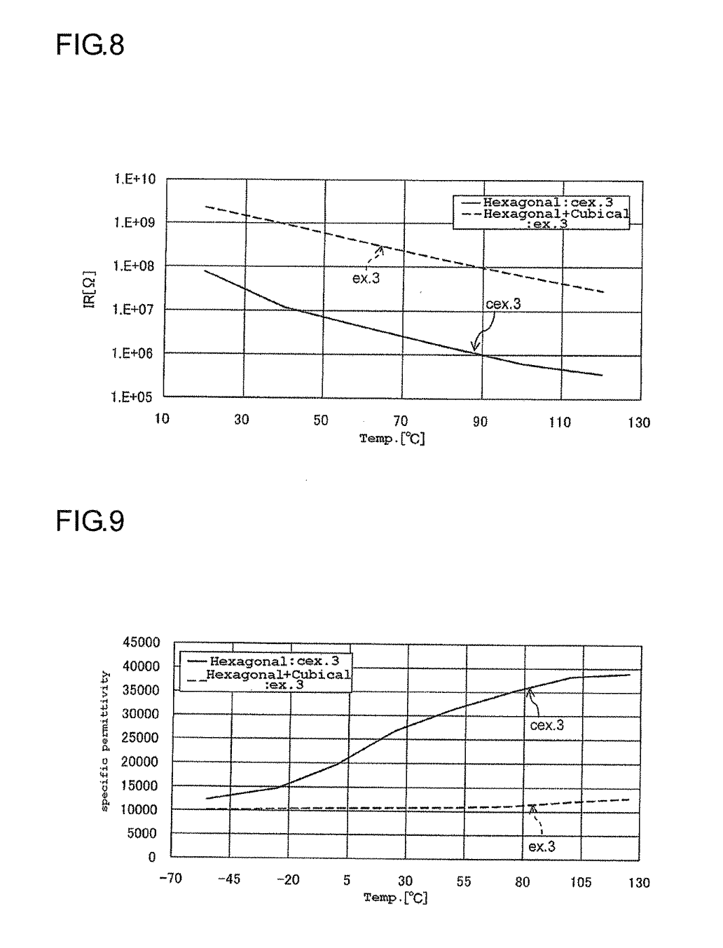

Furthermore, for the obtained capacitor sample of the present example, insulation resistance and specific permittivity were evaluated. The results are shown by the dashed line “ex. 3” in FIG. 8 and FIG. 9.

### Comparative Example 3

Except for changing the oxygen partial pressure at firing to 10⁻¹ Pa, a capacitor sample was produced as with Example 3, and the measurements were done in the same procedures. As a result of measurement of X-ray diffraction (XRD) pattern for the dielectric layer by using X-ray diffractometer, only the peak specific to hexagonal barium titanate was observed. From this result, it was confirmed that the dielectric layer was formed by hexagonal barium titanate particle, in which the shell as shown in FIG. 2 was not formed, and grain boundary. For the obtained capacitor sample for the comparative example, insulation resistance and specific permittivity were evaluated. The results are shown by the solid line “cex. 3” in FIG. 8 and FIG. 9.

### Evaluation 2

As shown in FIG. 8 and FIG. 9, it was confirmed in Example 3 (ex. 3) that insulation resistance was improved and changes in both specific permittivity and insulation resistance with temperature were small while specific permittivity was lowered, compared to Comparative Example 3 (cex. 3). It was also confirmed in Example 3 that specific permittivity was considerably improved compared to Example 1.

### Example 4

Except for using any one of Dy, Gd, Ho, Y, Er, Yb, Ce and Bi instead of La as the element M1, a capacitor sample was produced as with Example 3, the measurements were done in the same procedures, and it was confirmed that the similar results were obtained as with Example 3. This may be because these elements have an effective ionic radius of −20% or more to +20% or less with respect to an effective ionic radius of 12-coordinated Ba²⁺, and are substituted for Ba, as with La.

### Example 5

Except for setting M2=Mn and 0<β≦0.2, a capacitor sample was produced as with Example 3, the measurements were done in the same procedures, and it was confirmed that the similar results were obtained as with Example 3. It was confirmed that properties can be improved in ease of particularly 0.03≦β≦0.2, further preferably 0.03≦β≦0.1.

### Example 6

Except for using any one of Ga, Cr, Co, Fe, Ir and Ag instead of Mn as the element M2, a capacitor sample was produced as with Example 5, the measurements were done in the same procedures, and it was confirmed that the similar results were obtained as with Example 5. This may be because these elements have an effective ionic radius of −20% or more to +20% or less with respect to an effective ionic radius of 6-coordinated Ti⁴⁺, and are substituted for Ti, as with Mn.

### Example 7

Except for setting 0.900≦A/B<1.04 as A/B, a capacitor sample was produced as with Example 3, the measurements were done in the same procedures, and it was confirmed that the similar results were obtained as with Example 3.

### Example 8

Except for using any one of Ga, Cr, Co, Fe, Ir and Ag instead of Mn as the element M2, a capacitor sample was produced as with Example 1, the measurements were done in the same procedures, and it was confirmed that the similar results were obtained as with Example 1. This may be because these elements have an effective ionic radius of −20% or more to +20% or less with respect to the effective ionic radius of 6-coordinated Ti⁴⁺, and are substituted for Ti, as with Mn.

### Example 9

Except for setting M1=La and 0<α≦0.1, a capacitor sample was produced as with Example 1, the measurements were done in the same procedures, and it was confirmed that the similar results were obtained as with Example 1. It was confirmed that properties can be improved particularly in case of 0<α≦0.003.

### Example 10

Except for using any one of Dy, Gd, Ho, Y, Er, Yb, Ce and Bi instead of La as the element M1, a capacitor sample was produced as with Example 9, the measurements were done in the same procedures, and it was confirmed that the similar results were obtained as with Example 9.

### Example 11

Except for changing β in the range of 0.003≦α≦0.2 but excluding 0.15, a capacitor sample was produced as with Example 1, the measurements were done in the same procedures, and it was confirmed that the similar results were obtained as with Example 1.

### Example 12

Except for changing A/B in the range of 0.900≦A/B≦1.04 but excluding 1.000, a capacitor sample was produced as with Example 1, the measurements were done in the same procedures, and it was confirmed that the similar results were obtained as with Example 1.

### Example 13

Except for forming tetragonal shell by adding tetragonal BaTiO₃ as an additive instead of changing oxygen partial pressure at firing, a capacitor sample was produced as with Example 1, and the measurements were done in the same procedures. As a result of measurement of X-ray diffraction (XRD) pattern for the dielectric layer by using X-ray diffractometer, it was confirmed that the peak specific to cubical or tetragonal barium titanate can be displaced by changing an amount added of the tetragonal BaTiO₃ and that it is possible to control the core shell, as with Example 1, Example 2 and Comparative Example 1 shown in FIG. 4.

### EXPLANATION OF SYMBOLS

1 multilayer ceramic capacitor

2 dielectric layer
2a dielectric particle
22a core
24a shell
2b grain boundary

3 internal electrode layer

4 external electrode

10 capacitor element body

1. A dielectric ceramic composition in which dielectric particles are formed,
said dielectric particles comprising
a core comprised of hexagonal barium titanate,
a shell formed on an outer circumference of said core and comprised of cubical or tetragonal barium titanate.

2. The dielectric ceramic composition as set forth in claim 1, wherein
said hexagonal barium titanate is expressed by a general formula, (Ba_{1-α}M1_{α})_{A} (Ti_{1-β}M2_{β})_{B}O₃;
an effective ionic radius of said M1 is −20% or more to +20% or less with respect to an effective ionic radius of 12-coordinated Ba²⁺;
an effective ionic radius of said M2 is −20% or more to +20% or less with respect to an effective ionic radius of 6-coordinated Ti⁴⁺; and
said A, B, α and β satisfy the following relations: 0.900≦(A/B)≦1.040, 0≦α≦0.10 and 0≦β≦0.2.

3. The dielectric ceramic composition as set forth in claim 2, wherein
said cubical or tetragonal barium titanate is different in crystal structure from said hexagonal barium titanate but is expressed by said general formula, (Ba_{1-α}M1_{α})_{A} (Ti_{1-β}M2_{β})_{B}O₃.

4. The dielectric ceramic composition as set forth in claim 1, wherein
a grain boundary is formed between said dielectric particles, and additive elements are dispersed in said grain boundary and/or said shell.

5. The dielectric ceramic composition as set forth in claim 2, wherein
a grain boundary is formed between said dielectric particles, and additive elements are dispersed in said grain boundary and/or said shell.

6. The dielectric ceramic composition as set forth in claim 3, wherein
a grain boundary is formed between said dielectric particles, and additive elements are dispersed in said grain boundary and/or said shell.

7. An electronic component having a dielectric layer, wherein
said dielectric layer is comprised of the dielectric ceramic composition as set forth in claim 1.

8. An electronic component having a dielectric layer, wherein
said dielectric layer is comprised of the dielectric ceramic composition as set forth in claim 2.

9. An electronic component having a dielectric layer, wherein
said dielectric layer is comprised of the dielectric ceramic composition as set forth in claim 3.

10. An electronic component having a dielectric layer, wherein
said dielectric layer is comprised of the dielectric ceramic composition as set forth in claim 4.

11. An electronic component having a dielectric layer, wherein
said dielectric layer is comprised of the dielectric ceramic composition as set forth in claim 5.

12. An electronic component having a dielectric layer, wherein
said dielectric layer is comprised of the dielectric ceramic composition as set forth in claim 6.
